(19) United States
(12) Patent Application Publication
(10) Pub. No.: US 2010/0161277 A1
(43) Pub. Date: Jun. 24, 2010

(54) NETWORKED EVALUATION SYSTEM

(75) Inventor: Andrew MEIKLE, Booval (AU)

Correspondence Address: LADAS & PARRY LLP, 26 WEST 61ST STREET, NEW YORK, NY, 10023, US

(73) Assignee: ELKIEM CENTRE PTY LIMITED.

(21) Appl. No.: 12/343,870

(22) Filed: Dec. 24, 2008

(51) Int. Cl. G06F 15/00

(52) U.S. Cl. 702/182

(57) ABSTRACT

A networked organization performance evaluation system based on an integrated number of Performance Components quantified by a computerized statistical analysis of data collected from within the organization. The data is collected by a network accessible interface generated by software resident on computers and databases maintained by the system. The Performance Components include: (a) an Achievement Component and a Failure Component representing end points of a Performance Range, (b) an Exposure Component of an identified population of said organization, (c) an Individual Exposure component of an individual within the population, (d) a Significant Personal Pleasure Component associated with the Achievement Component, (e) a Significant Personal Discomfort Component associated with the Failure Component, (f) a Meaning Component, (g) a Strategy and Plan Component. Each of the Performance Components is assigned a ranked value derived through the statistical analysis.

The present invention relates to computer implemented data collection and analysis systems and, more particularly, to computerised analysis for the identification of performance characteristics and performance improvement.

### BACKGROUND

Tools for the improvement of performance in human activities in commercial and organizational institutions, is important both from the aspects of productivity, efficiency and profitability, as well as satisfaction of the personnel concerned.

Numerous organizations offer seminars, workshops and improvement guides which aim to identify organizational and resource deficiencies and seek to motivate the human resources into greater commitment and productivity.

In perhaps the majority of these systems, there is little quantitative analysis of the multi-faceted parameters at play so that there is little or no opportunity to benchmark a current situation, identify those parameters which are most in need of improvement, or to measure any improvement which may occur.

It is an object of the present invention to address or at least ameliorate some of the above disadvantages.

### Notes

1. The term “comprising” (and grammatical variations thereof) is used in this specification in the inclusive sense of “having” or “including”, and not in the exclusive sense of “consisting only of”.
2. The above discussion of the prior art in the Background of the invention, is not an admission that any information discussed therein is citable prior art or part of the common general knowledge of persons skilled in the art in any country.

### BRIEF DESCRIPTION OF INVENTION

Accordingly, in a first broad form of the invention, there is provided a networked organization performance evaluation system; said system based on an integrated number of Performance Components; said Performance Components quantified by means of a computerized statistical analysis of data collected from within said organization; said data collected by means of a network accessible interface generated by software resident on computers and databases maintained by said system; said Performance Components including:
(a) an Achievement Component and a Failure Component; said Achievement Component and said Failure Component representing end points of a Performance Range,
(b) an Exposure Component of an identified population of said organization,
(c) an Individual Exposure component of an individual within said population,
(d) a Significant Personal Pleasure Component associated with said Achievement Component,
(e) a Significant Personal Discomfort Component associated with said Failure Component,
(f) a Meaning Component,
(g) a Strategy and Plan Component,
   said components integrated within an Approach Component associated with said Organization, and wherein each of said Performance Components is assigned a ranked value derived through said statistical analysis.

Preferably, said statistical analysis of said data collected from within said organization is based on ranking responses to groupings of questions presented to participating individuals within said organization.

In another broad form of the invention, there is provided a networked evaluation system; said system including collected data from within an organisation; said collected data input through a network accessible interface; software resident on servers and databases maintained by said system providing a statistical analysis of said collected data; said analysis identifying at least one weakest performance indicating component of a plurality of performance indicating components characterising said organisation.

Preferably, said collected data is obtained through a structured pool of statements provided in formatted web pages over said network to participating respondents within said organization.

Preferably, said statements are provided in groups of statements in each of said formatted web pages; available values for assignment by said respondents represented by a series of radio buttons.

Preferably, values accorded said statements by said respondents within said organization are analysed within a number of said performance indicating components.

Preferably, each of said components includes a selection of statements from said pool of statements.

Preferably, each said statement of said selection of statements within a components is assigned a relative weight.

Preferably, each said weight is a proportion of 100% within each of said components; said weights assigned by a system designer.

Preferably, an assigned said weight is applied to an average of all values accorded by respondents to each statement within a said component to derive a weighted value for said statement; a summation of said weighted values determining a diagnostic indicator value for said component.

Preferably, said performance indicating components characterising a said organisation include an individual respondent's perception within said organization of;

(a) approach,

(b) achievement,

(c) exposure,

(d) individual exposure,

(e) failure,

(f) significant emotional pleasure

(g) significant emotional discomfort

(h) meaning

(i) strategy and plan

Preferably, said system generates a selection of graphical output displays.

Preferably, said displays include a graphical representation of average values and range of values accorded by respondents to said statements.

Preferably, said displays include a graphical representation of each of said performance indicating components ranked according to respective diagnostic indicator values of said components.

Preferably, said displays include representations of selected said diagnostic indicator values for comparison with a critical diagnostic indicator value; said representation accompanied by explanatory text.

Preferably, said displays include an overview of interacting performance indicating components accompanied by respective rankings of said components; said display facilitating identification of said at least one weakest performance indicating component.

Preferably, said system is applied iteratively; a first iteration of said system providing a performance benchmark of said organization; improvements in said at least one weakest performance indicating component identified in said first iteration determined by a succeeding iteration.

In another broad form of the invention, there is provided a method of determining at least one weakest performance indicating component of an organization; said method including the steps of:
(a) maintaining software of a networked evaluation system on servers and databases of an evaluation agency,
(b) generating displays for gathering values assigned by respondents within a said organization to a pool of statements,
(c) analysing said values assigned to said statements; said statements grouped within performance indicating components,
(d) deriving performance indicating values from said gathered values by means of relative weightings applied to said gathered values within each of said performance indicating components,
(e) displaying selected graphical output displays of analysed said gathered values and of said performance indicating components,
   wherein a ranking of said performance indicating values determines said at least one weakest performance indicating components.

Preferably, each of said performance indicating components includes a set of statements selected from said pool of statements.

Preferably, said performance indicating values comprise a bench mark of said organization's performance; iterative applications of said method allowing evaluation of improvement in said at least one weakest performance indicting component and identification of a new at least one weakest performance indicating component.

### BRIEF DESCRIPTION OF DRAWINGS

Embodiments of the present invention will now be described with reference to the accompanying drawings wherein:

FIG. 1 is a schematic representation of one preferred implementation of a networked evaluation system according to the invention,

FIG. 2 is a relational diagram of major Performance Components of the evaluation system of FIG. 1,

FIG. 2A is an amplification of the Performance Components of FIG. 2, indicating some of the terminology commonly in use within an organization as these relate to the Performance Components,

FIG. 2B is a summary of definitions and functions of the Performance Components of FIGS. 2 and 2A,

FIGS. 3 and 4 are two examples of the strength and effectiveness status of the Performance Components of FIG. 2,

FIG. 5 is a sample graphical ranked summary of Performance Indicators within an organization,

FIG. 6 is a sample graphical ranked representation of the Performance Components of FIG. 2,

FIGS. 7 to 9 are examples of web based display screens generated by the system of FIG. 1 for gathering assigned values to a pool of statements,

FIGS. 10 to 13 shows in tabular form a sample of grouping of statements, from the pool of statements of FIGS. 7 to 9 into performance indicating Components,

FIG. 14 is an example of a graphical output display showing average values assigned to the statements of FIGS. 7 to 9,

FIG. 15 is an example of a graphical output display showing comparisons between one critical indicating component and selected other performance indicating components.

### DETAILED DESCRIPTION OF PREFERRED EMBODIMENTS

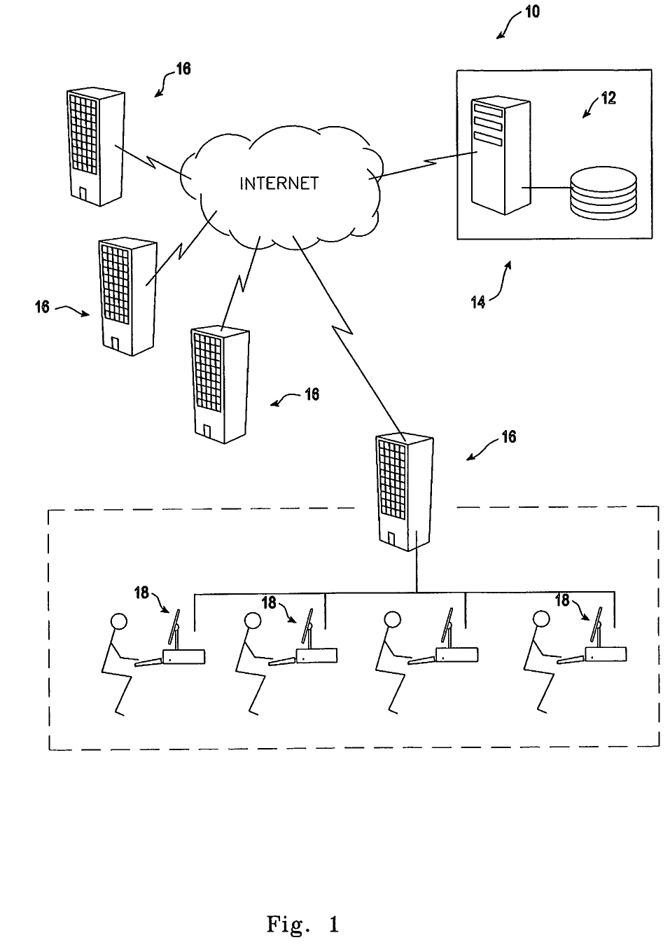

With reference to FIG. 1, the present invention provides for a system 10 (the High Performance Environmental Structure (HPES)) and method implemented over a distributed network, for example the Internet, of gathering comprehensive data on the attitudes, perceptions and performance levels of the human resources within organizations. By means of comparative quantification, weighting and statistical analysis, critical performance indicators can be identified and evaluated to indicate those particular areas in which an organization is weakest.

The system of the present invention explains the specific circumstances that trigger improved performance in human beings. It is the culmination of research into performance environments from around the world. The focus of this research was to identify and understand the dynamics that exist within environments that produce very high performance amongst the populations within those environments.

Some of the researched environments used in the ongoing development of the system include: Harvard Business School, MIT, NASA, The Juilliard School of Music, The Royal College of Music (London), the military and military Special Forces in the United States, United Kingdom and Australia, Samurai Grandmasters, Yupik Eskimo Community, Australia's National Institute of Dramatic Art (NIDA), Olympic Sporting teams, and many more.

The system distills the research findings into a working model that can be applied to any environment in which a population is being asked to perform, in particular businesses and corporations. The system describes the 9 components that exist within all performance environments and the balance which stimulates the best possible performance from the population within them. The system breaks down these 9 components into 14 indicators, that provide a more detailed analysis of the performance fundamentals of any environment.

The HPES software involved in the performance evaluation of the present invention includes three elements: the Survey Tool, a Custom.Net Application, and the Crystal Report.

1. The Survey Tool

The survey tool employed in the present invention, incorporates an “off the shelf” software package (Professional Quest) providing a user interface which enables survey participants to be administered and data from responses to be collected and stored on a PQuest SQL server database which was designed on the following platforms: Web Server: IIS6, Nicrosoft.NET Framework 2.0, ASP AJAX Extension 1.0, NET Programming Language & IDE: ASP.NET 2.0 (C#), MS Visual Studio 2006 SP1.

2. Custom.NET Application

A custom Net application, the “BEAGLE Tool” allows the transfer and manipulation of data from the PQuest database. This application is an invention which allows the High Performance Environmental Structure Model to become a tangible item with a tangible output.

The System administrator then uses the NET application to assemble the data using the survey maintenance functions.

From a programmers perspective The.NET code has two purposes:
Administrative platform to maintain data for reports.
Produce chart images for reports.

The HPES of the present invention is the basis from which the Net application has been constructed. Without the HPES Model the custom application would not have been created. This application has enabled the HPES Model to become a functioning tool (the HPES Diagnostic Tool) to diagnose the relative strengths and weaknesses of a client's performance environment.

The HPES Diagnostic Tool enables leaders to apply the HPES Model to their own environment & quickly build a detailed picture of the existing performance environment within their organisation. The report created by the HPES Diagnostic tool enables a leader to accurately pinpoint which components are absent or lacking and what changes could be made in order to effect significant improvements in performance.

The HPES Diagnostic Tool has a high degree of built-in versatility in order to allow leaders to build a detailed picture of the performance environment within an individual team, leadership layer or business unit—or whatever breakdown best suits their organisational structure.

Functions of the BEAGLE tool includes the following functions:

Survey Maintenance

1. Component, Questions, Weightings

2. Component Category

3. Indicators, Questions, Weightings

4. Demographic Labels

5. Group Demographic

6. Group Demographic Category

7. Manage Report

8. Calculate Survey Results

Functions 1 and 3 allow the system administrator to assign weighting values to Components and Indicators. These weightings have been designed based on unique research within the context of the present invention. The “Beagle Tool” allows these weightings to be applied to the data collected via the Survey Tool when it generates the scores for various Components and Indicators.

Components

The table below is the Beagle Tools interface for managing the Components of the system.

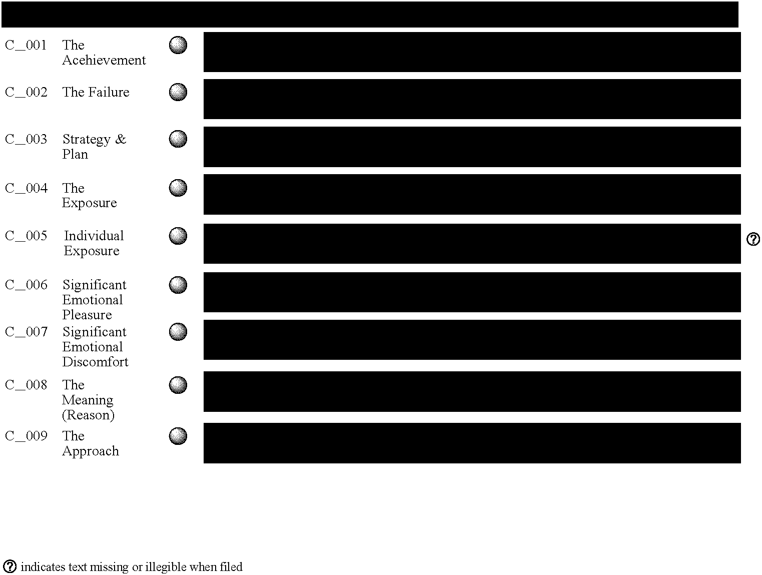

A portion of the Questions and their respective weightings relative to the component they are connected to via the Questions Relationship Function is shown below:

Component Name: The Achievement

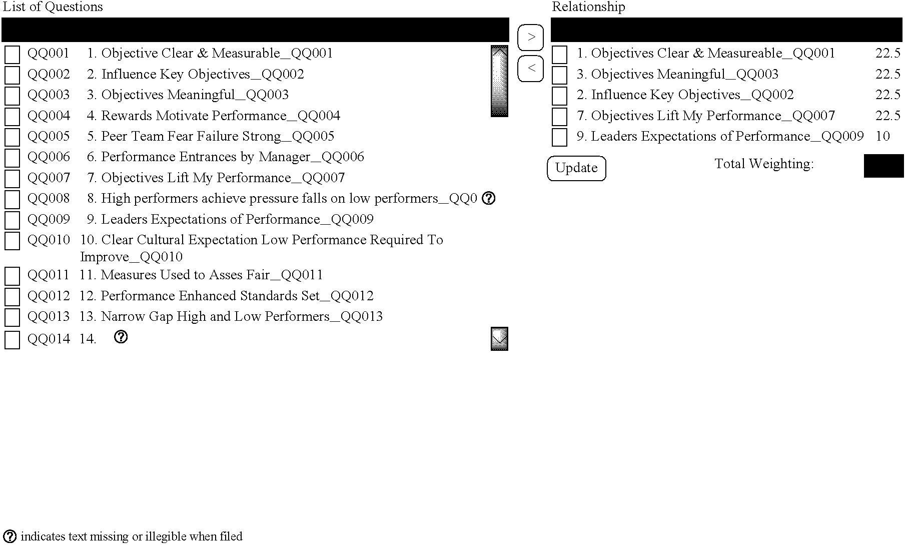

Function 2, the “component category”, allows the components to be grouped in sections within the report.

Function 4 “Demographic Labels” instructs the system which data fields contain the demographic labels attached to the response data and provides the information used to filter the data.

Function 5 “Group Demographic” is used to setup the data filtering rules which group the data from specified demographics in order to calculate the scores for the components and indicators. It also contains fields which provide labeling information for the report.

Function 6 “Group Demographic Category” allows Group demographics to be catagorised so that they may be compared for example Divisions or Leadership Levels.

Function 7 “Manage Report” is used to construct the data for reporting. This function creates the design for the report booklets, it stores the data in the HPES_DWH database which the crystal report accesses to generate the report.

Function 8 “Calculate Survey Results” begins the stored procedure process which performs all the calculations and sorting of data required to run the crystal report.

It should be noted that the Questions Relationship Function for Components and Indicators are identical. However each Component and Indicator has different groups of questions and different weightings. A question may be used to contribute to a number of different Indicators and Components. The Question is selected from the list of available questions and a weighting is entered according to the evaluation system's Questions and Weightings document. The Questions and Weightings Document has been developed based on research and is an integral part of the Beagle Process.

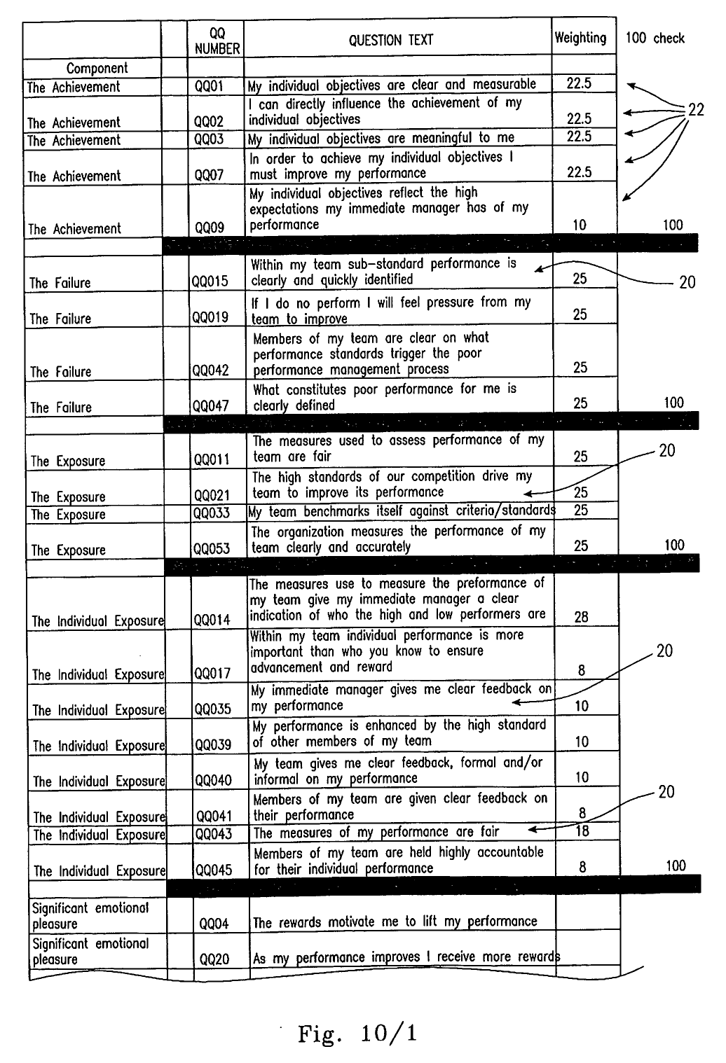

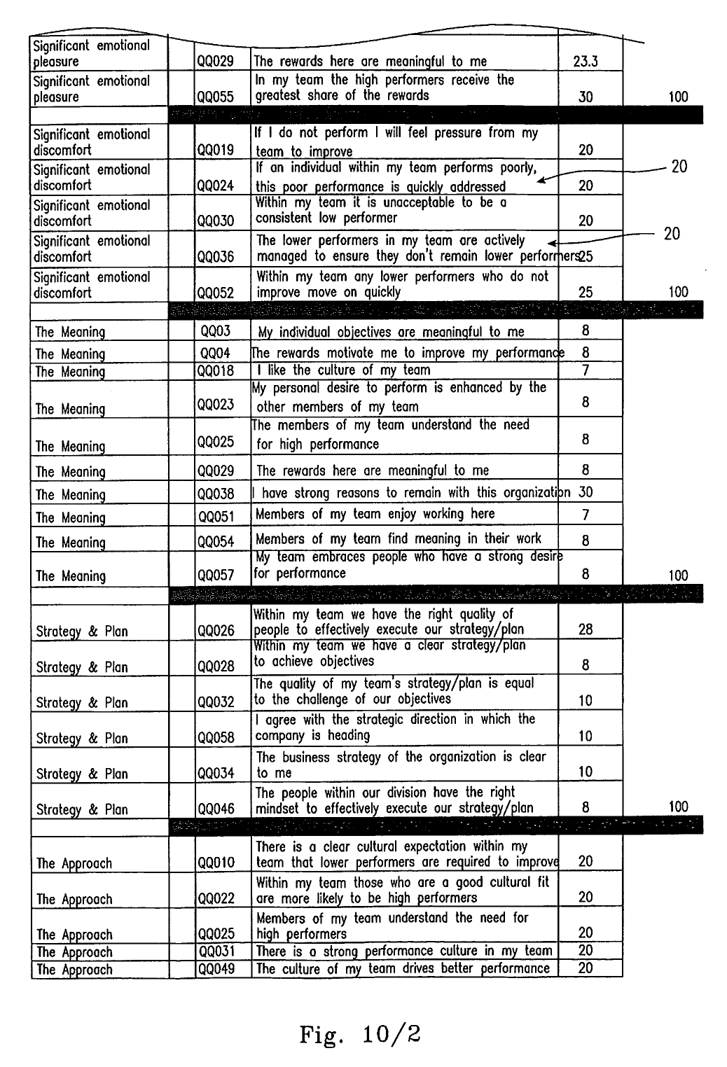

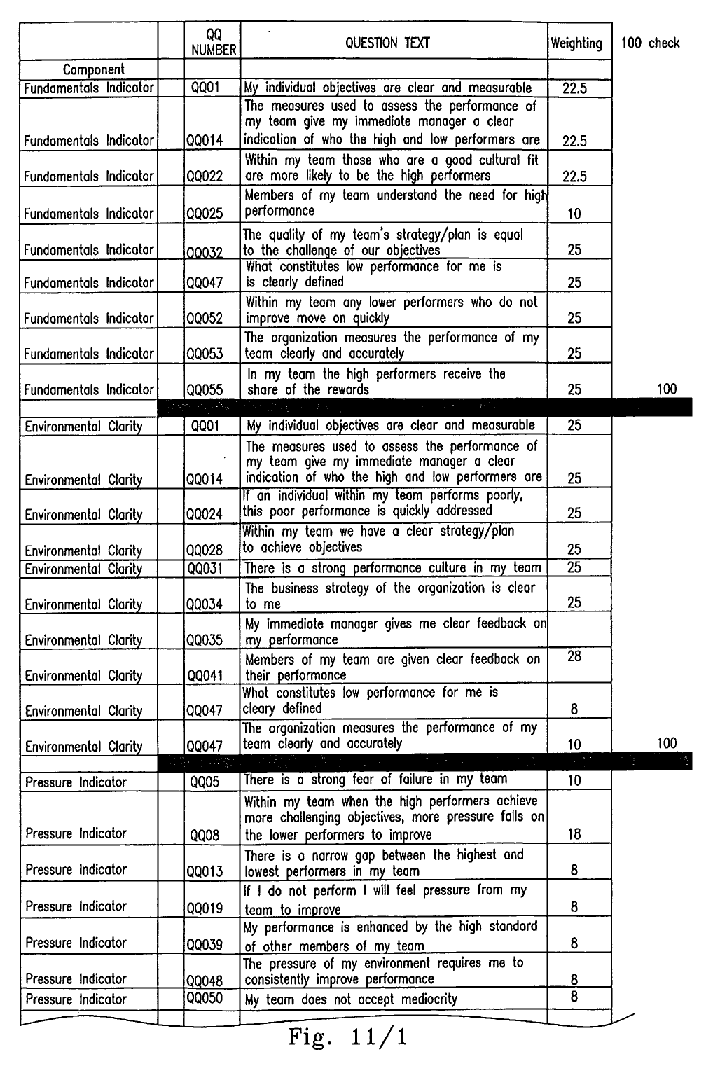

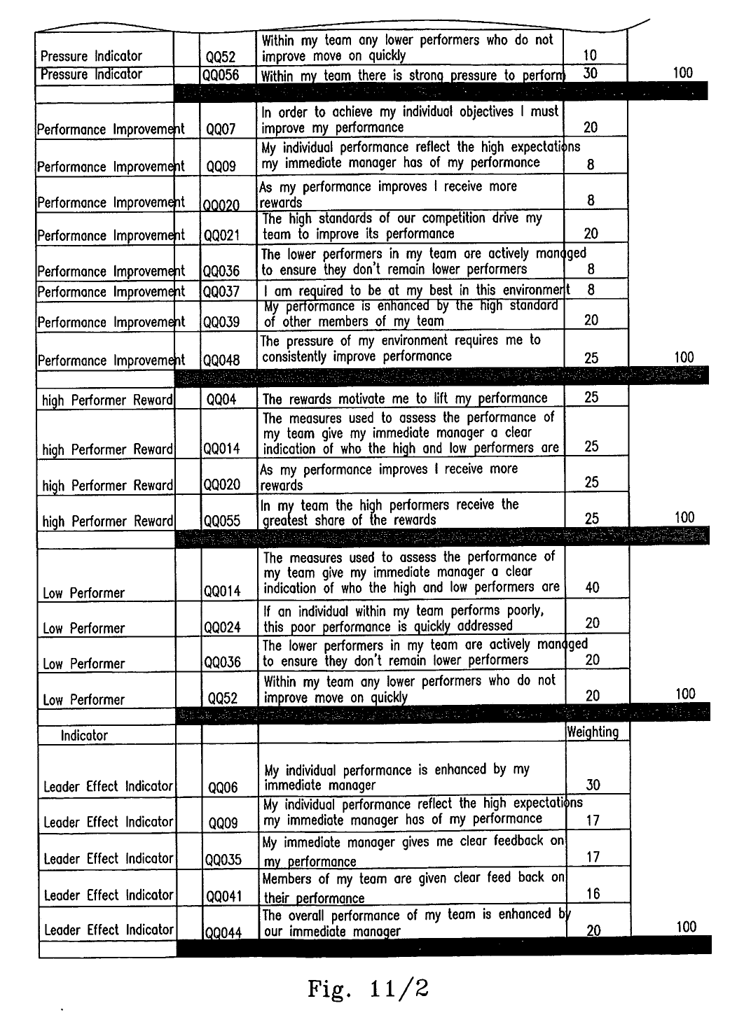

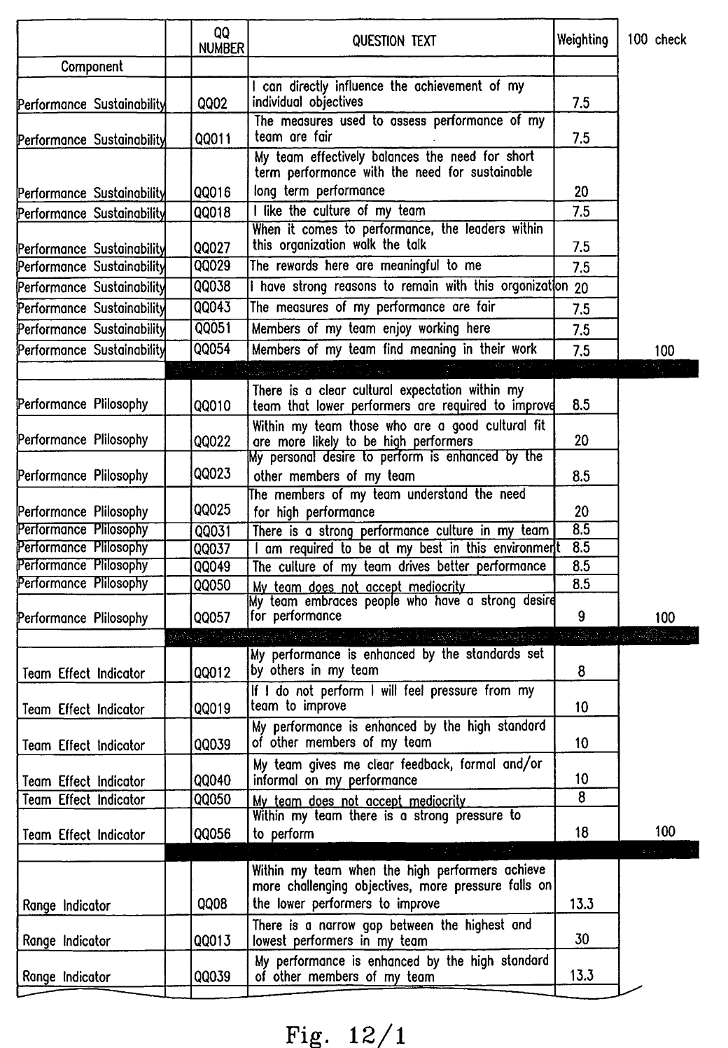

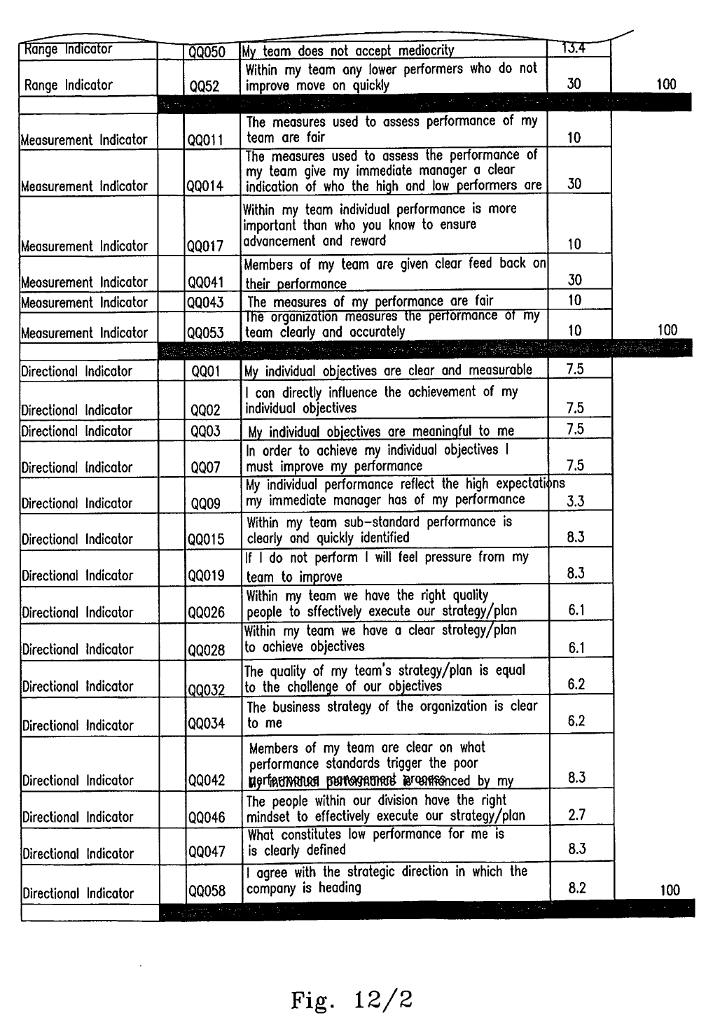

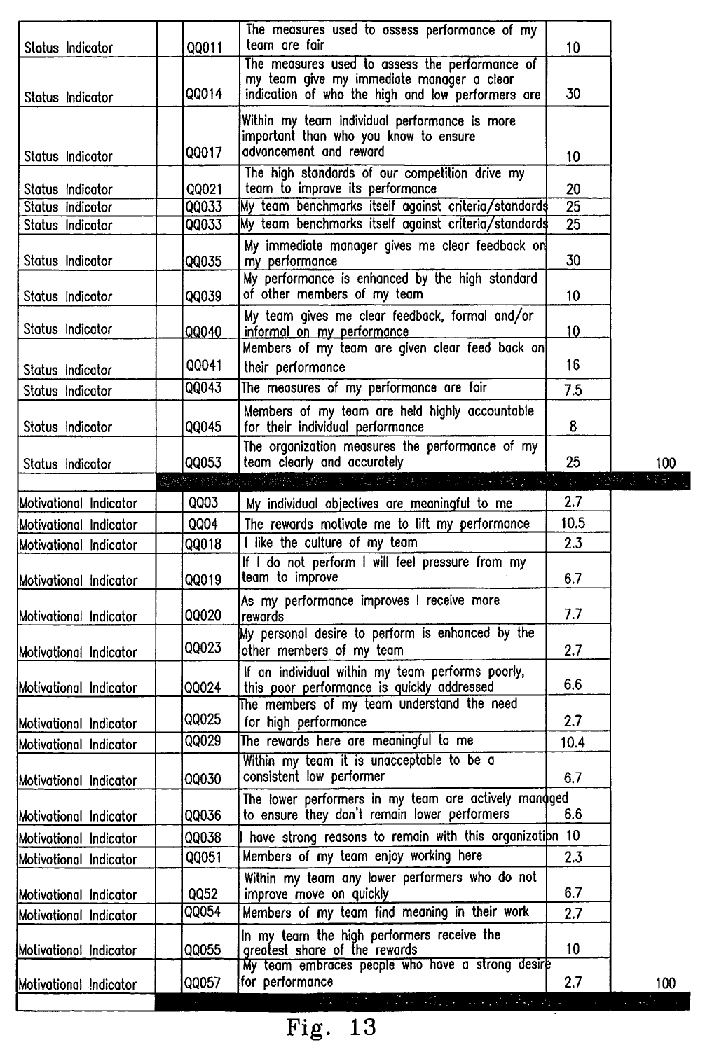

The questions and their weightings which determine the values ultimately assigned by the software to the Components and Indicators, are shown in FIGS. 10 to 15.

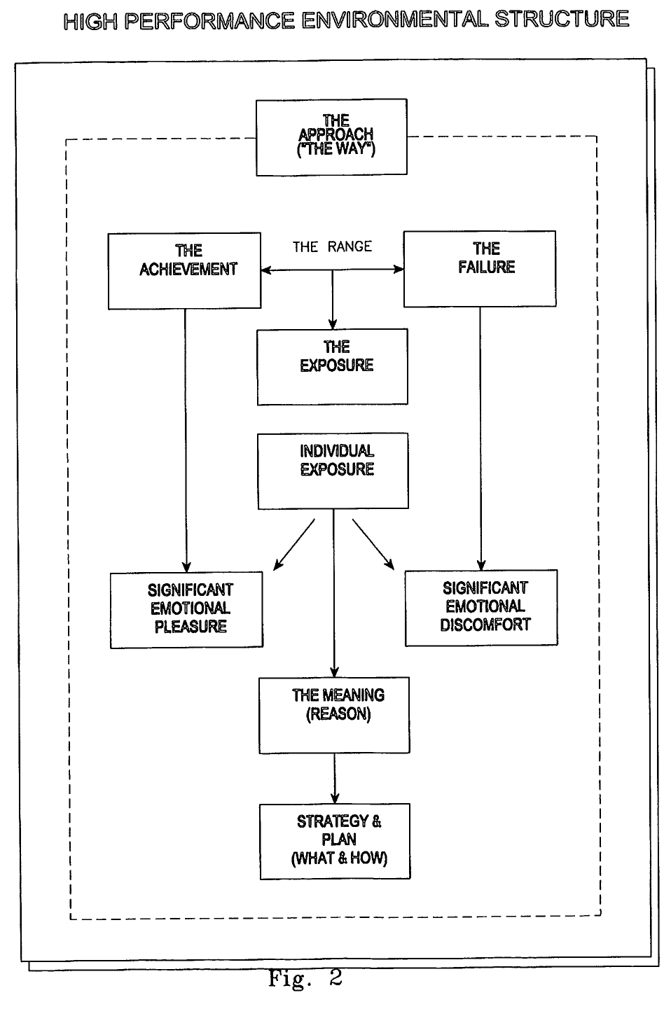

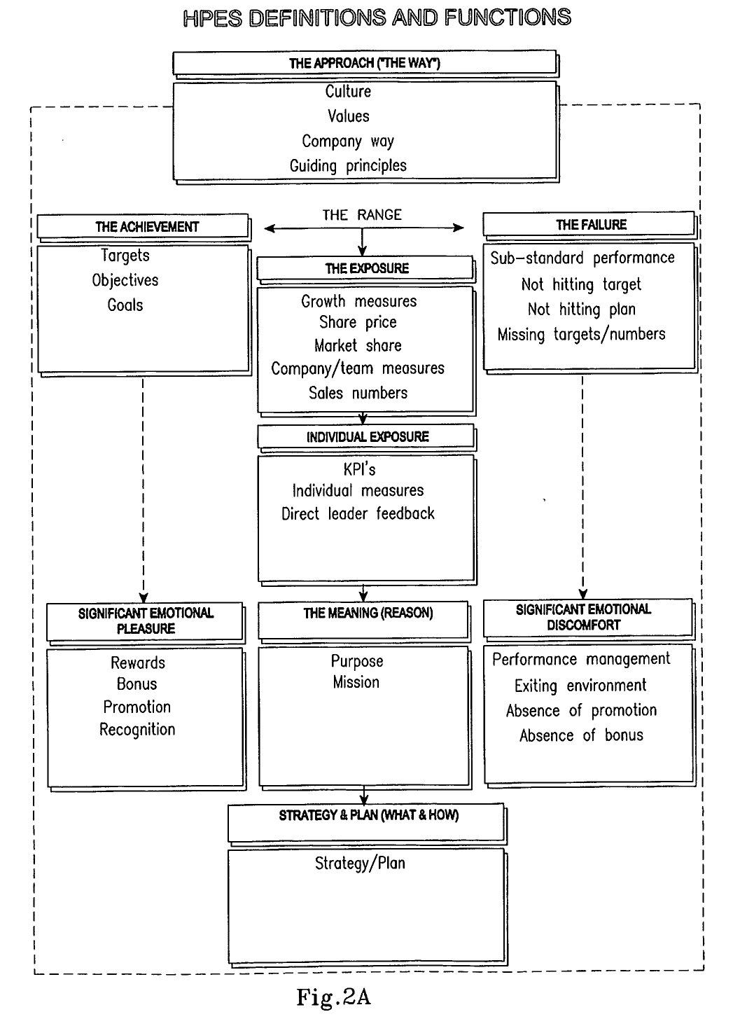

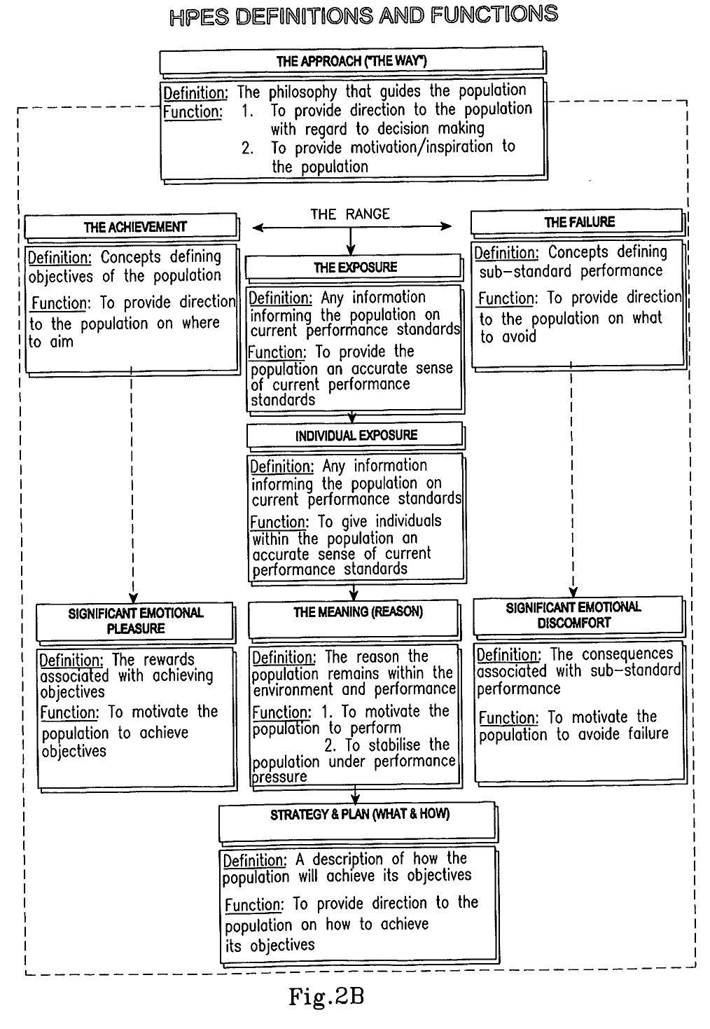

The evaluation system of the invention identifies nine major Components which research has shown underlie any performance environment as shown in FIG. 2.
1. The Achievement. This component is a directional component. In an effective High Performance Environmental structure, it provides those within the performance environment with direction on where to aim.
   Definition: Concepts defining objectives of the population
   Function: To provide direction to the population on where to aim
2. The Failure. This component is a directional component. In an effective High Performance Environmental Structure, it provides those within the performance environment with direction on what to avoid.
   Definition: Concepts defining sub-standard Performance
   Function: To provide direction to the population on what to avoid
3. Strategy and Plan. This component is a directional component. In an effective High Performance Environmental Structure, it provides those within the performance environment with direction on what to do.
   Definition: A description of how the population will achieve its objectives
   Function: To provide direction to the population on how to achieve its objectives
4. The Exposure. This component is a status component. In an effective High Performance Environmental Structure, it provides those within the performance environment with clarity on a team's current situation or performance status.
   Definition: Any information informing the population on current performance standards
   Function: To provide the population an accurate sense of current performance status
5. Individual Exposure. This component is a status component. In an effective High Performance Environmental Structure, it provides individuals within the performance environment with clarity on their current individual situation or performance status within a team setting.
   Definition: Any information informing individuals within the population of current performance standards
   Function: To give individuals within the population an accurate sense of current performance status
6. Significant Emotional Pleasure. This component is a motivational component. In an effective High Performance Environmental Structure, it provides those within the performance environment with reward-based motivation.
   Definition: The rewards associated with achieving objectives
   Function: To motivate the population to achieve objectives
7. Significant Emotional Discomfort. This component is a motivational component. In an effective High Performance Environmental Structure, it provides those within the performance environment with avoidance-based motivation.
   Definition: The consequences associated with sub-standard performance
   Function: To motivate the population to avoid failure
8. The Meaning. This component is a motivational component. In an effective High Performance Environmental Structure, it provides those within the performance environment with reason-based motivation.
   Definition: The reason the population remains within the environment and performs
   Function: 1. To motivate the population to perform,
      2. To stabilise the population under performance pressure
9. The Approach. This component is both directional and motivational. In an effective High Performance Environmental Structure, it provides a philosophical basis that can both motivate through aspiration and provide direction with regards to decision making.
   Definition: The philosophy that guides the population
   Function: 1. To provide direction to the population with regards to decision making,
      2. To provide motivation/inspiration to the population.

As shown in FIGS. 2 and 2A, these Components are related in a particular structured way. Within any organization it can be shown that there is a “range”. See RANGE INDICATOR at page 24.

Generally, the narrower the range of the values between the best (ACHIEVEMENT) and worst (FAILURE) performance, the greater the pressure to perform.

Achievement may have both an immediate element of conferring Significant Emotional Pleasure, such when the group or an individual perceives a successful outcome of some aspired goal, and subsequently when that successful outcome is given some official recognition, for example by the awarding of some reward or sign of recognition. These two elements of Significant Emotional Pleasure are indicated by the dotted and full lines leading to this Component.

Similarly, Significant Emotional Discomfort may be experienced as an immediate perception (dotted line) and subsequently, when this is expressed in some formal manner after evaluation via the Exposure or Individual Exposure Components.

The Meaning or Reason Component, identifies the underlying reasons for a group or individual's motivation for being within the organization. Based on this, groups and individuals will go about strategizing, planning and trying to work out how to perform in the environment of the organization; thus the Strategy and Plan Component.

Finally, these Performance Components function within some guiding philosophical framework or culture of the organization as indicated by the Approach Component.

The definitions of the nine Performance Components and their functions are summarized in FIG. 2B.

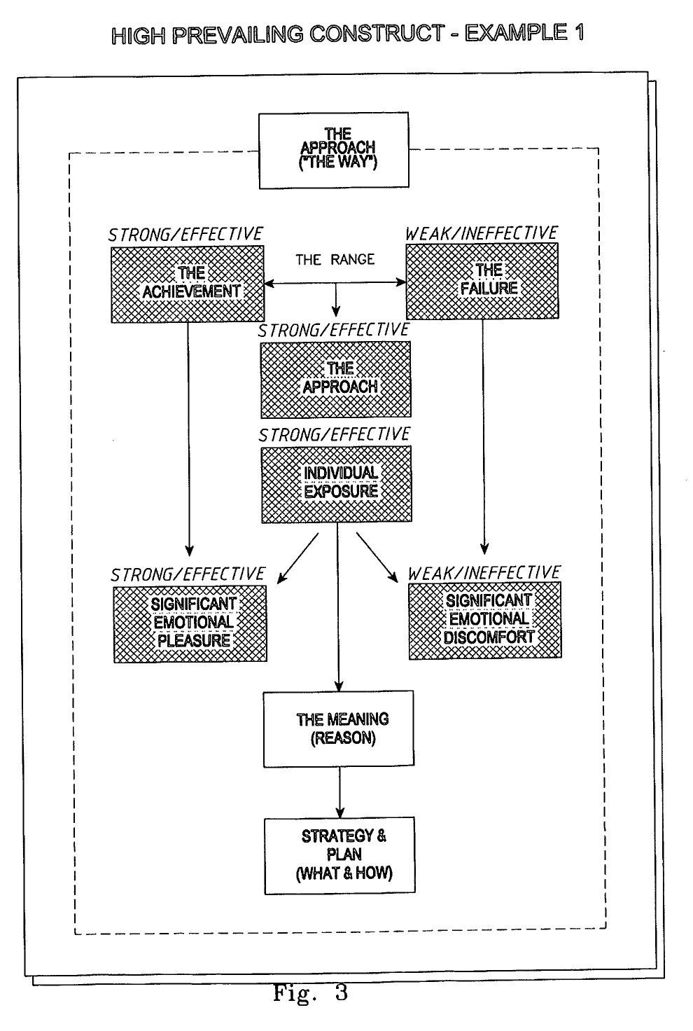

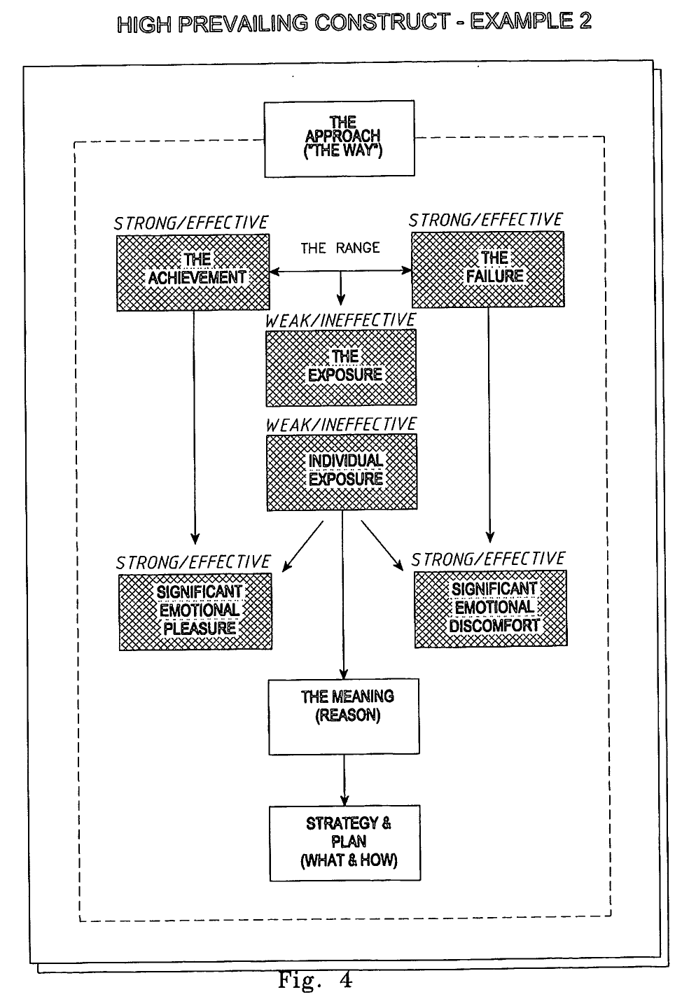

Examples of the interrelationship of the central “tight six” of the Performance Components are illustrated in FIGS. 3 and 4. Performance Components within an organization environment clearly may be of varying strengths. In some environments for example as shown in FIG. 3, the Achievement Component and Pleasure component are very strong, but the Failure component and the Discomfort Component are very weak. Even given that the identification of groups and individuals as afforded by the Exposure and Individual Exposure Components are also strong, one of the effects of this state of affairs is complacency within the organization, there being no effective consequences for under performance. Another effect is that pleasure would moderate and high performers will start to leave the organization through lack of differentiation from under achievers.

In a second example shown in FIG. 4, the Achievement Component is working well and is effective. The rewards (Significant Emotional Pleasure) component is also working well and effective. This time the Failure Component is also working well and effective, as is the Significant Emotional Discomfort. However in this case the exposure at both the group level and the individual level are weak and ineffective.

The implication of this situation is that the measures are weak so that it is difficult to tell who are the high and who are the low performers. One undesirable effect of this is that under performing individuals will identify who are the decision makers and try to build protective relationships with them leading to distracting currents of politics, cronyism, interpersonal conflicts, causing stress within the organization.

Another effect of this situation in the six components is that some under performing individuals will start faking their performance so that instead of being motivated towards higher performance, they will innovate to on how to look like a high performer.

Indicators

The table below shows the Beagle Tool interface for management Indicators (Function 3)

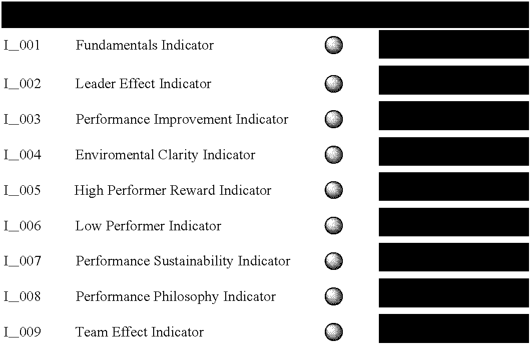

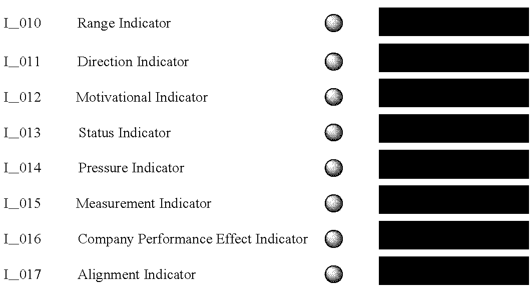

The Fundamentals Indicator comprises the basic elements of performance in the performance environment. It aims to answer the question ‘Are the basic elements of the High Performance Environmental Structure present in this environment?’

The Following are some of the elements contributing to the Fundamentals Indicator:
Clear, measurable objectives
Accuracy of individual performance measures
Perception that high performers receive the greatest share of the rewards
Perception that low performers improve or move on quickly

The Leader Effect Indicator gives us an understanding of the perceived impact of leadership within the environment. It aims to answer the question ‘Are the leaders having a strong performance effect within the environment?

The Following are some of the elements contributing to the Leader Effect Indicator:
Strong leader expectations of performance
Leader performance feedback
Effect of leaders on individual performance
Effect of leaders on team performance

The Performance Improvement Indicator tells us the extent to which the current environment stimulates an increase in performance standards. Clearly, in a performance context, the aim is to have an environment that stimulates a performance improvement in those present. The Performance Improvement Indicator aims to answer the question ‘Is this environment perceived to be stimulating a performance improvement from the individuals within it?’.

The Following are some of the elements contributing to the Performance Improvement Indicator:
Requirement for performance improvement to reach individual objectives
A perception that low performers are actively managed to ensure they don't remain low performers
Environmental requirement for consistent improvement
Influence of individual high performers as a motivator for others to improve

The Environmental Clarity Indicator gives us an idea of the degree of clarity in the High Performance Environmental Structure. Simple cause effect relationships flow from environmental clarity; for example high pressure with a low level of environmental clarity will create disorganised performance behaviour. The Environmental Clarity Indicator aims to answer the question ‘How clearly defined are the components of the HPES?’.

The Following are some of the elements contributing to the Environmental Clarity Indicator:
Clear, measurable objectives
Perceived clarity of unacceptable performance standards
Clarity and accuracy of individual and team performance measures
Clarity of the organisation's business strategy
Clarity of individual's strategies to achieve objectives

The High Performer Reward Indicator tells us whether or not the greater share of the rewards is perceived to be distributed to the highest performers. In a performance context, it is important that those who make the greater contribution receive a greater share of the rewards. The High Performer Reward Indicator aims to answer the question ‘Are the high performers perceived to be receiving the greater share of the rewards?’.

The Following are some of the elements contributing to the High Performer Reward Indicator:
Clarity of individual performance measures
Perception that rewards are motivation for increased performance
Increased rewards as a motivator for improved individual performance
Perception that high achievers receive a greater share of the rewards

The Low Performer Indicator tells us whether or not low performers are perceived to be receiving some form of consequence for their low performance. In a performance context, it is important that those who are not making a contribution receive less rewards or some consequence. The Low Performer Indicator aims to answer the question ‘Are the low performers perceived to be receiving some form of consequence for their low performance?’.

The Following are some of the elements contributing to the Low Performer Indicator:
Perception that those individuals who should be having their poor performance addressed are receiving attention
Perception that low performers are actively managed to ensure they don't remain low performers
Perception that low performers improve or move on quickly
Perceived accuracy of individual measures

The Performance Sustainability Indicator tells us the extent to which performance can be sustained over extended time periods in this environment. The Performance Sustainability Indicator aims to answer the question ‘Is high performance sustainable in this environment?’.

The Following are some of the elements contributing to the Performance Sustainability Indicator:
Fairness of individual performance measures
Effective balance of short term performance needs with long term sustainability requirements within the environment
Meaningful objectives and rewards
Pleasure associated with performance

The Performance Philosophy Indicator tells us the extent to which the ‘philosophy’ of the environment enhances performance. Some performance environments have a very strong performance philosophy which in turn can have a positive performance effect. The Performance Philosophy Indicator aims to answer the question ‘Is the philosophy of this environment enhancing performance?’.

The Following are some of the elements contributing to the Performance Philosophy Indicator:
General understanding of the need for high performance
Perception of a clear performance culture
Expectations that lower performers must improve
Perception that culture drives high performance
Perception that the team does not accept mediocrity

The Team Effect Indicator aims to identify whether ‘teaming’ or being part of a team is having a positive performance effect in the environment. The Team Effect Indicator aims to answer the question ‘Is ‘teaming’ or being part of a team enhancing performance in the environment?’.

The Following are some of the elements contributing to the Team Effect Indicator:
Perception of team based pressure to perform
Perception of strong team expectations
Perception that the team provides clear feedback on performance
Perception that the team does not accept mediocrity

The Range Indicator gives us an indication of the range of acceptable performance within the performance environment. This is an important indicator as both the highest and lowest performers will set benchmarks and standards for other individuals within the environment. That being said, there is no such thing as a perfect range. The aim of understanding the range is to understand its effect on performance. For example, a wide range can reduce pressure where a narrow range can increase pressure. The Range Indicator aims to answer the question ‘How wide is the range of acceptable performance standards perceived to be?’.

The Following are some of the elements contributing to the Range Indicator:
Influence of individual high performers as a motivator for others to improve
Perceived gap between high and low performers
The effect on low performers of high performers achieving challenging objectives
Perception that lower performers improve or move on quickly

The Directional Indicator gives us an indication of the strength of directional components in the High Performance Environmental Structure. A strong Directional Indicator indicates that people in the environment know ‘where to go’ and ‘how to get there’.

The Following are some of the elements contributing to the Directional Indicator:
Leader expectations
Clear, measurable objectives
Individual clarity of the organisation's business strategy
Clarity of individual's strategies to achieve objectives
Clear and timely identification of sub-standard performance

The Motivational Indicator gives us an indication of the strength of the motivational components in the High Performance Environmental Structure. A strong Motivational Indicator indicates that performance desire is high in the environment.

The Following are some of the elements contributing to the Motivational Indicator:
Understanding of the need for high performance
Meaningful objectives and rewards for reaching them
Perception of consequences for poor performance
Perception that higher performers receive greater rewards

The Status Indicator gives us an indication of the strength of the status components in the High Performance Environmental Structure. A strong Status Indicator indicates that a team or individual's performance is being accurately measured or assessed.

The Following are some of the elements contributing to the Status Indicator:
Accuracy of individual performance measures
Fairness of individual performance measures
Clear feedback given
Clear and timely identification of sub-standard performance

The Pressure Indicator tells us how much performance pressure there is perceived to be within the environment. In a performance context, pressure is seen as a necessary component but one that needs careful monitoring and balancing with other environmental factors. The Pressure Indicator aims to answer the question ‘How much performance pressure is perceived to be in this environment?’.

The Following are some of the elements contributing to the Pressure Indicator:
Environmental requirement for consistent improvement
Perceptions about the strength of pressure in the environment
Influence of individual high performers as a motivator for others to improve
Perceived gap between high and low performers

The Company Performance Effect Indicator gives us an understanding of how the company's actions influence the performance environment. It aims to answer the question ‘Is the Company having a strong performance effect with the environment?’.

The Following are some of the elements contributing to the Company Performance Effect Indicator:
Strong Company expectations of performance
Company performance feedback
The effect of the Company in individual performance
Effect of the Company on team performance

The Alignment Indicator comprises elements important to be aligned in the relationship between the company and the licensees/franchisees. It aims to answer the question ‘Are we aligned on key business elements?’.

The Following are some of the elements contributing to the Alignment Indicator:
Alignment on business plan
Alignment on tactics and actions with regards to (Internal HR practice)
Alignment on tactics and actions with regards to (internal policy)
Expectations of future profitable growth

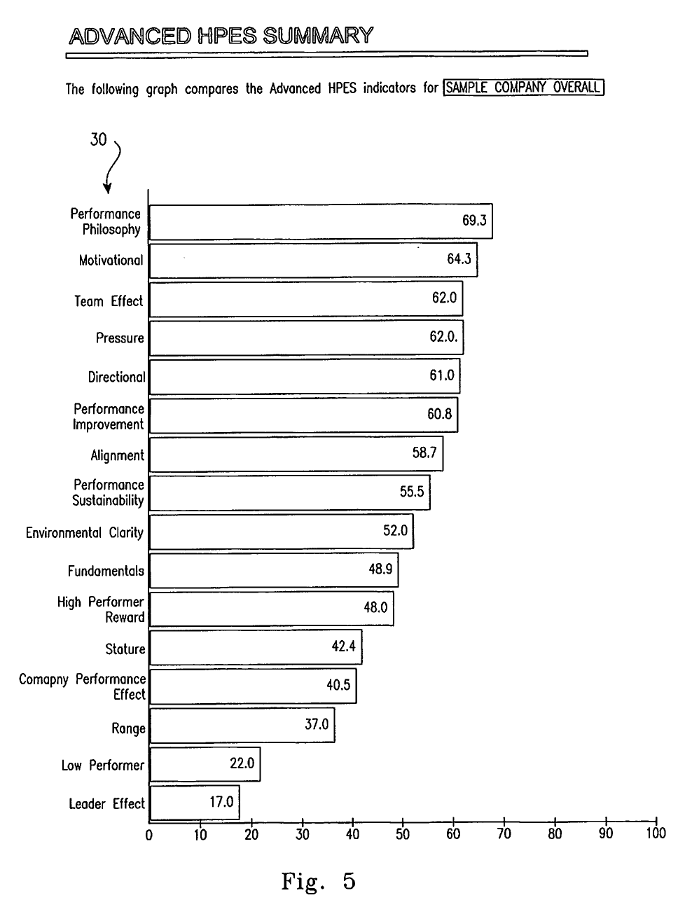

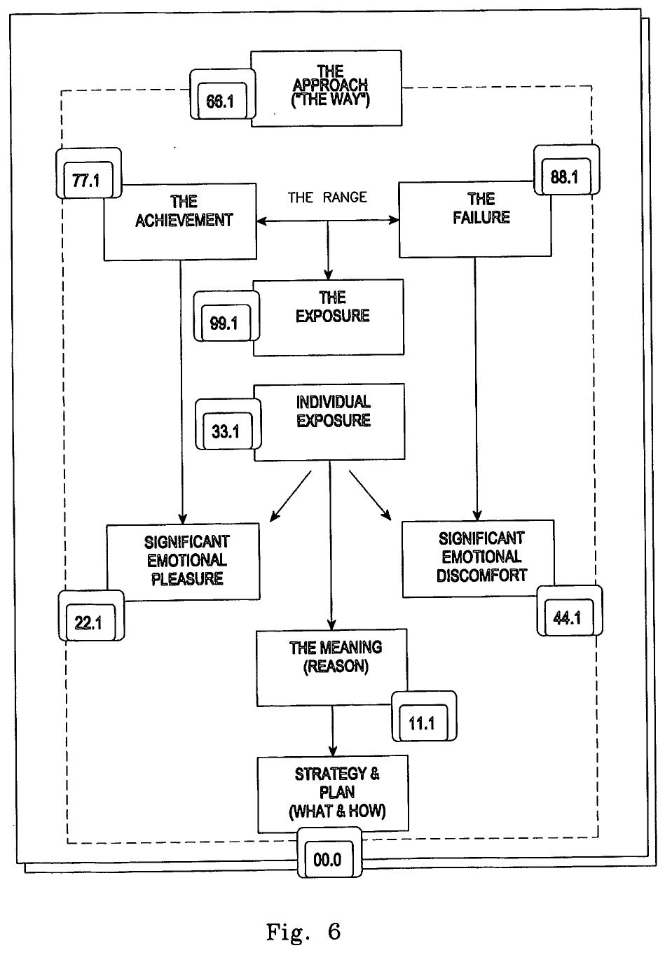

The Indicator scores generated from the Survey data are inserted into an Indicator Summary as shown in the sample of FIG. 5.

3. Crystal Report

Finally, the System Administrator uses Crystal Reports to run a custom built crystal report file to generate the document in order to present the data/findings to the client.

Again with reference to FIG. 1, the networked evaluation system 10 of the present invention is implemented on a computer system 12 comprising servers and databases of an Evaluation Agency 14. In one preferred embodiment as shown in FIG. 1, the system operates over the Wide Area Network (WAN) of the Internet so as to be accessible to disparate organisations 16 at remote locations from the Agency. However in another preferred embodiment, the evaluation system may equally be implemented over a Local Are Network LAN) for example within a large organization.

In any case it is the software resident on servers and databases of the system which disseminates the user interface displays provided on display devices 18 accessing the system and which carries out the analysis of the data gathered from respondents within an organization.

At the heart of the present system, evaluation of the performance indicators underlying the operation of an organization, relies on the gathering of assigned values of a pool of structured statements collected by means of the Survey Tool.

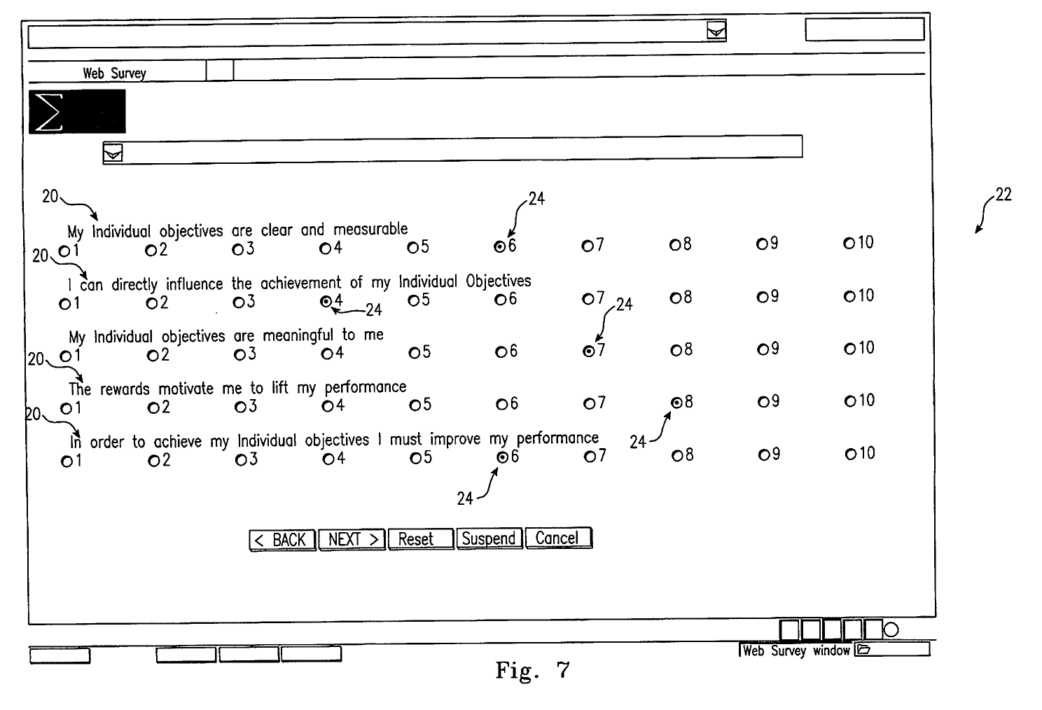

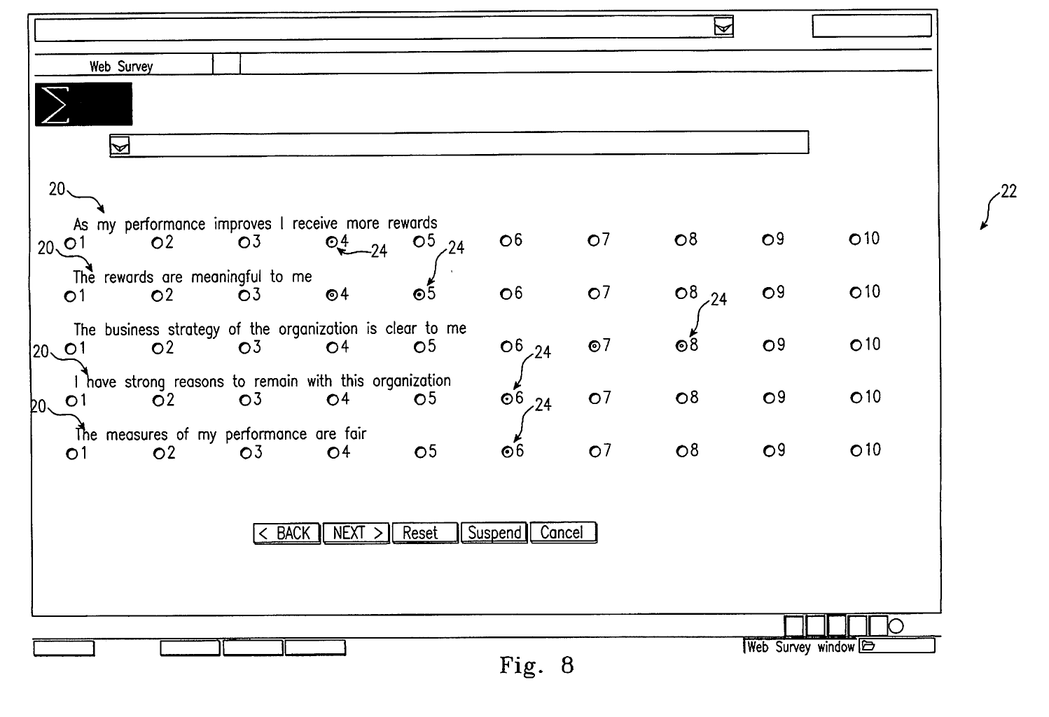

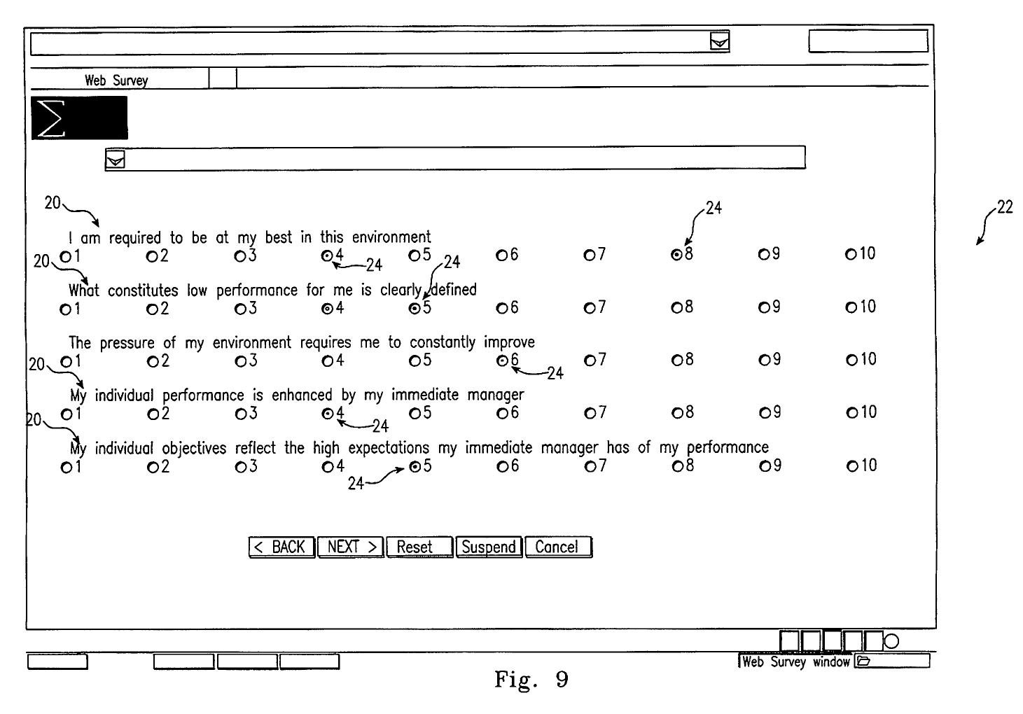

As shown in FIGS. 7 to 9, statements 20 are made available in groups in formatted web pages for display on computer monitors within the organization under consideration. Help screens accessible from embedded links may be provided to guide respondents through the process. Respondents are generally selected for participation in the on-line survey by the organization and preferably include a cross section of employee characteristics.

Statements 20 are presented in groups, preferably five statements per group, on each web page 22 as shown in the examples of FIGS. 7 to 9. Each respondent is requested to assign a value, for example between 1 and 10, to each statement 20 by activating one of the ten “radio” buttons 24 associated with the statement 20, the selected value representing the degree to which the respondent is in agreement with the statement.

The values assigned by respondents to the pool of statements are analysed by the system to generate performance indicator values in a number of performance indicating components, each of which includes a particular selection of the statements from the pool of available statements. Some of the performance indicating components may include the same statement as other performance indicating components. An example of the grouping of the pool of statements 20 into some of the available performance indicating components 30 is shown in FIGS. 10 to 13. There is no direct correspondence between the sequence of statements of the web pages 22 and the arrangement of statements 20 in the various performance indicating components listed in FIGS. 10 to 13; the selection being determined according to known contributions of the statements to the performance indicating components concerned. Although each statement 20 of the pool of statements is answered only once by a respondent, the assigned value will be used by the system in each of the various performance indicating components in which it appears for the specific evaluation of that component's score.

As can be seen from the performance indicating components 30 in FIGS. 10 to 13, components include those discussed in detail above and shown in FIG. 2, “Achievement”, “Failure”, “Exposure”, “Individual Exposure”, “Significant Emotional Pleasure”, “Significant Emotional Discomfort”, and “Meaning”.

Statements that are included in these performance indicating components, may include those which seek to focus and rate a respondent's attitude to objectives within the respondent's responsibilities, factors enhancing or inhibiting performance, and assessment of relative performance within a group or team. Other performance indicating components combine statements which seek to elicit the degree of understanding of the factors which have bearing on the respondent's attitude, level of satisfaction or dissatisfaction within the group or team, or indeed within the organization.

A particular feature of the present system is the weights 32 applied to the statements in each of the performance indicating components in the analysis. Each component 30 has a nominal value of 100% apportioned by the system designer between the statements 20 that make up the component. Thus for example in FIG. 10 the first performance indicating component “The Achievement” which includes statements QQ1, QQ2, QQ3, QQ6 and QQ9, apportions 10% to QQ9 with the remaining 90% equally distributed between the remaining four statements, each of which is given a weight of 22.5%. These weights are based on research and experience in evaluating the effective contribution of questions to the indicators of performance in various organizations. The weights of statements within a performance indicating component are determined by a system designer based on research of the influence of statements within organizations. They may be modified from time to time depending on the results of ongoing research.

For the system to derive a performance indicator value for a particular component, the average of all respondents' values to each statement 20 are summed and an average statement value for the component obtained. This average value expressed as a percentage is multiplied by the weight assigned to the statement in this component to give a statement score. This is repeated for each statement in the component and the statement scores summed to give a final component performance indicator value. The process is illustrated in the following table for the first performance indicating components of FIG. 5, “The Achievement”.

| | Average | Average | Multiplied | | |
|---|---|---|---|---|---|
| Statement | score | as % | by | Weighting | Result |
| QQ1 | 6.2 | 62 | X | 22.5 | 13.95 |
| QQ2 | 5.3 | 53 | X | 22.5 | 11.925 |
| QQ3 | 4.2 | 42 | X | 22.5 | 9.45 |
| QQ6 | 8.1 | 81 | X | 22.5 | 18.225 |
| QQ9 | 9.6 | 96 | X | 10 | 9.6 |

| | |
|---|---|
| TOTAL SCORE | 63.15 |

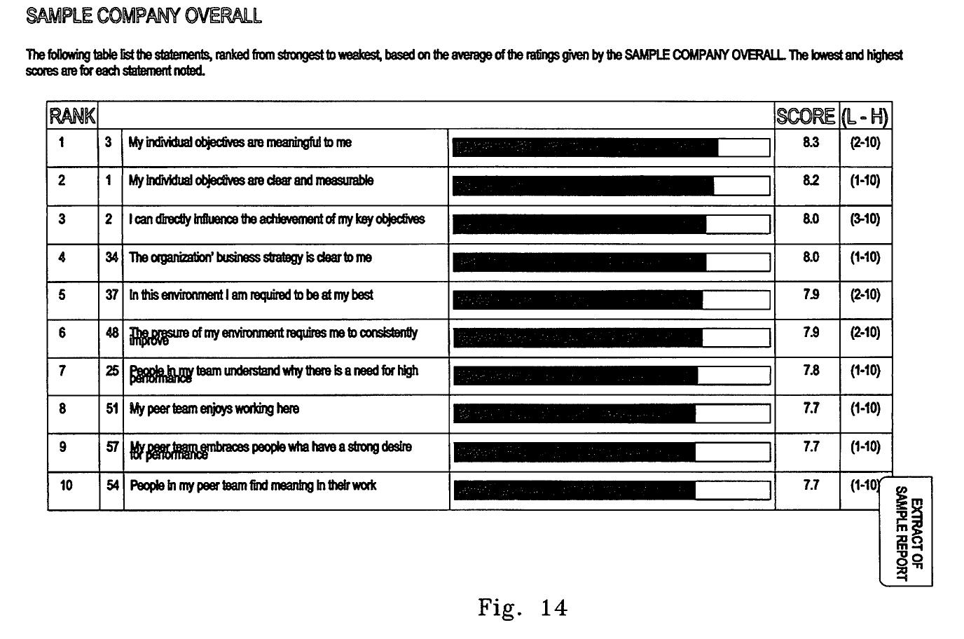

Thus the values of the statements 20 as entered into the web pages 22 provided by the system are evaluated according to the performance indicating components 30 in which they are included and weighted to provide a large number of diagnostic indicator values of an organization. The software of the system manipulates these results to generate a number of statistical output displays and graphic overviews for guidance by management. For example as shown in FIG. 14, a graphical display can be provided allowing management to review the average of values and the range of values assigned to any of the statements 20 presented to respondents via the web pages 22. An example of an overview graphic output is shown at FIG. 5 where a number of critical performance indicating components 30 are shown together with their weighted performance indicator values and ranking.

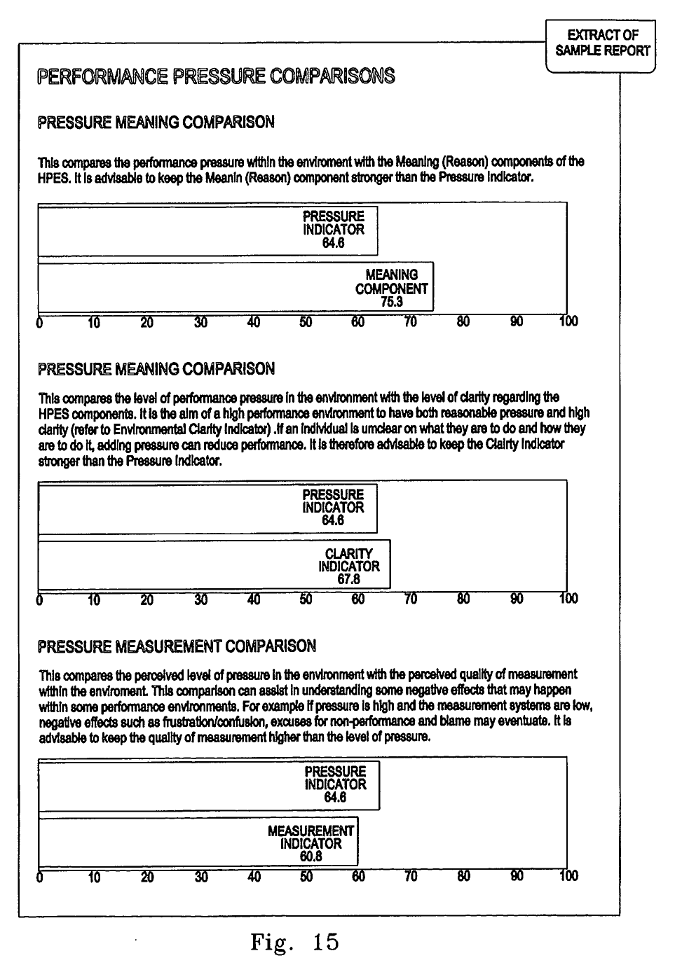

Another graphical output display is shown in FIG. 15 in which one critical performance indicating component is compared with other selected indicating components. In this type of output the system may include guidance as to the interpretation that may be placed one the juxtaposition of values of the compared performance indicating components and provides a visual indication of potential problem areas within an organization.

FIG. 14 shows an organization overview display in which the interaction of a group of performance indicating components are shown schematically together with their overall ranking.

Two objectives are achieved by the statistical analysis of the present system. Firstly it allows the establishment of a benchmark of performance indicators of the condition of an organization at the time of the evaluation. Secondly it allows identification of the weaker and weakest performance indicators values of the organization.

In Use

In use, the strategic use of the networked evaluation system is to focus on the two weakest identified indicator values of the organization and which management recognizes as being detrimental to the organization's performance. Strategies may then be developed and target performance indicator values adopted towards which the organization will endeavour to move the performance in those components.

The process may be iterative. A follow up evaluation may show that the previously two weakest indicators are no longer so and the target scores have been met or exceeded, allowing the focus to switch to the now current two weakest and the process of developing strategies and target performance scores repeated.

The above describes only some embodiments of the present invention and modifications, obvious to those skilled in the art, can be made thereto without departing from the scope of the present invention.

1. A networked organization performance evaluation system; said system based on an integrated number of Performance Components; said Performance Components quantified by means of a computerized statistical analysis of data collected from within said organization; said data collected by means of a network accessible interface generated by software resident on computers and databases maintained by said system; said Performance Components including:
(h) an Achievement Component and a Failure Component; said Achievement Component and said Failure Component representing end points of a Performance Range,
(i) an Exposure Component of an identified population of said organization,
(j) an Individual Exposure component of an individual within said population,
(k) a Significant Personal Pleasure Component associated with said Achievement Component,
(l) a Significant Personal Discomfort Component associated with said Failure Component,
(m) a Meaning Component,
(n) a Strategy and Plan Component,
said components integrated within an Approach Component associated with said Organization, and wherein each of said Performance Components is assigned a ranked value derived through said statistical analysis.

2. The system of claim 1, wherein said statistical analysis of said data collected from within said organization is based on ranking responses to groupings of questions presented to participating individuals within said organization.

3. A networked evaluation system; said system including collected data from within an organisation; said collected data input through a network accessible interface; software resident on servers and databases maintained by said system providing a statistical analysis of said collected data; said analysis identifying at least one weakest performance indicating component of a plurality of performance indicating components characterising said organisation.

4. The system of claim 3, wherein said collected data is obtained through a structured pool of statements provided in formatted web pages over said network to participating respondents within said organization.

5. The system of claim 4, wherein said statements are provided in groups of statements in each of said formatted web pages; available values for assignment by said respondents represented by a series of radio buttons.

6. The system of claim 4, wherein values accorded said statements by said respondents within said organization are analysed within a number of said performance indicating components.

7. The system of claim 3, wherein each of said components includes a selection of statements from said pool of statements.

8. The system of claim 4, wherein each said statement of said selection of statements within a components is assigned a relative weight.

9. The system of claim 8, wherein each said weight is a proportion of 100% within each of said components; said weights assigned by a system designer.

10. The system of claim 9, wherein an assigned said weight is applied to an average of all values accorded by respondents to each statement within a said component to derive a weighted value for said statement; a summation of said weighted values determining a diagnostic indicator value for said component.

11. The system of claim 3, wherein said performance indicating components characterising a said organisation include an individual respondent's perception within said organization of;
(j) approach,
(k) achievement,
(l) exposure,
(m) individual exposure,
(n) failure,
(o) significant emotional pleasure
(p) significant emotional discomfort
(q) meaning
(r) strategy and plan

12. The system of claim 3, wherein said system generates a selection of graphical output displays.

13. The system of claim 10, wherein said displays include a graphical representation of average values and range of values accorded by respondents to said statements.

14. The system of claim 12, wherein said displays include a graphical representation of each of said performance indicating components ranked according to respective diagnostic indicator values of said components.

15. The system of claim 12, wherein said displays include representations of selected said diagnostic indicator values for comparison with a critical diagnostic indicator value; said representation accompanied by explanatory text.

16. The system of claim 12, wherein said displays include an overview of interacting performance indicating components accompanied by respective rankings of said components; said display facilitating identification of said at least one weakest performance indicating component.

17. The system of claim 3, wherein said system is applied iteratively; a first iteration of said system providing a performance benchmark of said organization; improvements in said at least one weakest performance indicating component identified in said first iteration determined by a succeeding iteration.

18. A method of determining at least one weakest performance indicating component of an organization; said method including the steps of:
(f) maintaining software of a networked evaluation system on servers and databases of an evaluation agency,
(g) generating displays for gathering values assigned by respondents within a said organization to a pool of statements,
(h) analysing said values assigned to said statements; said statements grouped within performance indicating components,
(i) deriving performance indicating values from said gathered values by means of relative weightings applied to said gathered values within each of said performance indicating components,
(j) displaying selected graphical output displays of analysed said gathered values and of said performance indicating components,
wherein a ranking of said performance indicating values determines said at least one weakest performance indicating components.

19. The method of claim 18, wherein each of said performance indicating components includes a set of statements selected from said pool of statements.

20. The method of claim 18, wherein said performance indicating values comprise a bench mark of said organization's performance; iterative applications of said method allowing evaluation of improvement in said at least one weakest performance indicting component and identification of a new at least one weakest performance indicating component.
